(19) United States
(12) Patent Application Publication
(10) Pub. No.: US 2024/0304125 A1
(43) Pub. Date: Sep. 12, 2024

(54) IMAGE DISPLAY METHOD AND DEVICE

(71) Applicant: AAC Optics Solutions Pte. Ltd., Singapore (SG)

(72) Inventor: Ossi Pirinen, Tampere (FI)

(21) Appl. No.: 18/181,590

(22) Filed: Mar. 10, 2023

(51) Int. Cl. G09G 3/00; G09G 3/36

(52) U.S. Cl. CPC G09G 3/001; G09G 3/3611; G09G 2340/0435; G09G 2340/0464; G09G 2370/18

(57) ABSTRACT

The image display method according to the present disclosure includes: receiving an original image from an external image source, the original image has a plurality of lines of and a plurality of columns of pixels; determining whether resolution of the original image is greater than the maximum display resolution; in response to the resolution of the original image being greater than the maximum display resolution, sampling, in at least one of a line direction and a column direction of the original image, the plurality of lines of and the plurality of columns of pixels of the original image at intervals, to generate a×b sub-images, both a and b are positive integers, and at least one of a and b is greater than 1; and displaying the a×b sub-images one by one at a display frame rate F.

### TECHNICAL FIELD

Embodiments of the present disclosure relate to the field of image display technology, and in particular to an image display method and an image display device.

### BACKGROUND

With the development of image display technology, the demand for high-resolution image display is increasing rapidly. However, existing image display devices having low display resolution cannot display high-resolution images or video streams well, resulting in problems such as image blurring, jamming or the like, which greatly affect user experience.

Moreover, the optical waveguides used together with image display devices are hard to be manufactured with high resolution and light efficiency, and the existing optical waveguides have roughly full HD resolution and as poor as 1% light efficiency. The upgrading of equipment brings additional costs and burdens.

In order to at least partially address the above problems, the present disclosure proposes an image display method and an image display device.

### SUMMARY

Embodiments of the present disclosure provide an image display method and an image display device, which are at least conducive to improving user experience and reducing the cost of image display devices.

Some embodiments of the present disclosure provide an image display method applicable to an image display device having maximum display resolution. The method includes: receiving an original image from an external image source, the original image has a plurality of lines of and a plurality of columns of pixels; determining whether resolution of the original image is greater than the maximum display resolution; in response to the resolution of the original image being greater than the maximum display resolution, sampling, in a line direction of the original image, the plurality of columns of pixels of the original image at intervals, or sampling, in a column direction of the original image, the plurality of lines of pixels of the original image at intervals, or sampling, in the line direction and the column direction of the original image, the plurality of lines of and the plurality of columns of pixels of the original image at intervals, to generate a×b sub-images, where a refers to a number of sub-images generated by sampling in the line direction of the original image, b refers to a number of sub-images generated by sampling in the column direction of the original image, both a and b are positive integers, and at least one of a and b is greater than 1; and displaying the a×b sub-images one by one at a display frame rate F.

In some embodiments, sampling, in at least one of the line direction and the column direction of the original image, the plurality of lines of and the plurality of columns of pixels of the original image at intervals includes: sampling, in the line direction of the original image, the plurality of lines of pixels of the original image at an interval of (a-1) columns, and sampling, in the column direction of the original image, the plurality of columns of pixels of the original image at an interval of (b-1) lines.

In some embodiments, the image display device further has a display area for displaying the original image, and displaying the a×b sub-images one by one at the display frame rate F includes: determining a respective display position of each of the a×b sub-images in the display area; and displaying the a×b sub-images one by one at the display frame rate F based on display positions.

In some embodiments, determining the respective display position of each of the a×b sub-images in the display area includes: numbering, with consecutive natural numbers, each of the plurality of lines of pixels and each of the plurality of columns of pixels of the original image; and determining the respective display position of each of the a×b sub-images in the display area based on numberings of the plurality of lines of pixels and numberings of the plurality of columns of pixels.

In some embodiments, determining the respective display position of each of the a×b sub-images in the display area based on the numberings of the plurality of lines of pixels and the numberings of the plurality of columns of pixels includes: determining, based on the numberings of the plurality of lines of pixels and the numberings of the plurality of columns of pixels, a respective shifting direction and a respective shifting distance for each of the a×b sub-images relative to a center of the display area.

In some embodiments, displaying the a×b sub-images one by one at the display frame rate F based on the display positions includes: shifting, according to the respective shifting direction and the respective shifting distance, each of the a×b sub-images relative to the center of the display area; and displaying each of the a×b sub-images in the display area.

In some embodiments, the image display device further has a preset display frame rate f, and F=f×a×b.

In some embodiments, the method further includes: generating sub-images by an image interpolation algorithm.

In some embodiments, the image display device communicates with the external image source via an optical waveguide, and the optical waveguide includes at least optical fibers.

In some embodiments, the image display device includes a projector, a smart TV and VR glasses.

Some embodiments of the present disclosure provide an image display device including a memory and a processor. The memory is configured to store a computer program, which, when executed by the processor, causes the processor to implement operations of the image display method as illustrated above.

### BRIEF DESCRIPTION OF THE DRAWINGS

One or more embodiments are exemplarily illustrated in reference to corresponding accompanying drawing(s), and these exemplary illustrations do not constitute limitations on the embodiments. Unless otherwise stated, the accompanying drawings do not constitute scale limitations.

FIG. 1 is a flow chart of the image display method according to some embodiments of the present disclosure.

FIG. 2 shows an example of generating sub-images by sampling according to some embodiments of the present disclosure.

FIG. 3 is a flow chart of the image display method according to some embodiments of the present disclosure.

FIG. 4 shows exemplary sub-images with numberings of lines of and column of pixels of the original image according to some embodiments of the present disclosure.

FIG. 5 is flow chart of the image display method according to some embodiments of the present disclosure.

FIG. 6 shows an example of the display area for displaying each sub-image according to some embodiments of the present disclosure.

FIG. 7 shows an example of displaying sub-images at the display frame rate according to some embodiments of the present disclosure.

FIG. 8 is a structural schematic diagram of an image display device according to some embodiments of the present disclosure.

### DETAILED DESCRIPTION OF THE EMBODIMENTS

In the image display method provided by embodiments of the present disclosure, an original image is received from an external image source, the original image has a plurality of lines of and a plurality of columns of pixels; whether resolution of the original image is greater than the maximum display resolution is determined; in response to the resolution of the original image being greater than the maximum display resolution, the plurality of columns of pixels are sampled at intervals in a line direction of the original image, or the plurality of lines of pixels are sampled at intervals in a column direction of the original image, or the plurality of lines of and the plurality of columns of pixels are sampled at intervals in the line direction and the column direction, to generate a×b sub-images, herein a refers to a number of sub-images generated by sampling in the line direction of the original image, b refers to a number of sub-images generated by sampling in the column direction of the original image, both a and b are positive integers, and at least one of a and b is greater than 1; and the a×b sub-images is displayed one by one at a display frame rate F.

With the image display method provided by embodiments of the present disclosure, sub-images of low resolution are displayed one by one in appropriate display positions at high display frame rate by an image display device having relatively low display resolution, thereby enabling user to perceive corresponding original image of high resolution due to the principle of persistence of vision. In this way, on one hand, the image display devices having low display resolution can display images of high resolution clearly and smoothly, without significant image quality loss, thereby greatly improving user experience on image viewing; on the other hand, it is not necessary to update the existing image display devices, thereby reducing the cost of devices for displaying high-resolution images and further reducing resource waste.

Embodiments of the present disclosure will be described in detail below with reference to the accompanying drawings. In different drawings, identical or similar reference numerals denote the same elements.

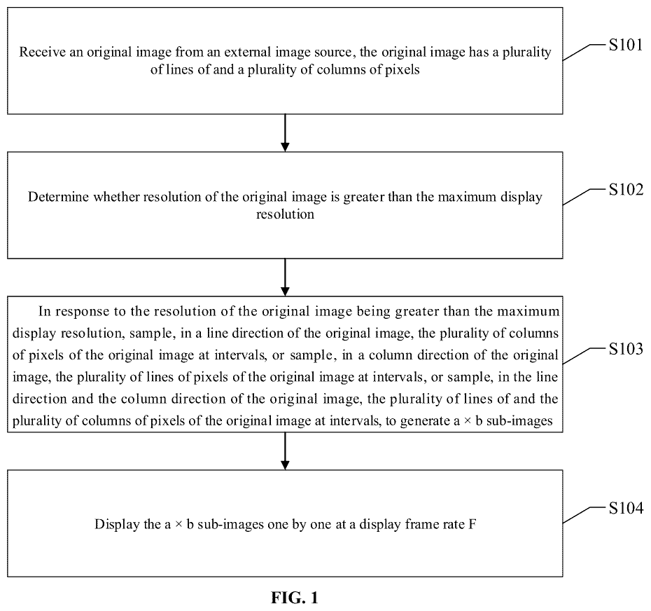

Referring to FIG. 1, FIG. 1 schematically shows a flow chart of the image display method according to some embodiments of the present disclosure. The method is applicable to an image display device and includes operations as follows.

At S101, the image display device receives an original image from an external image source. The external image source may be any appropriate entity or network resource provider, such as virtual reality (VR) players, Blu-Ray players, video websites, high definition image websites or the like. The original image is an image of high resolution, such as 4K, and has or is composed of a plurality of lines of and a plurality of columns of pixels.

At S102, the image display device determines whether resolution of the original image is greater than maximum display resolution of the image display device. When the resolution of the original image is less than the maximum display resolution of the image display device, the image display device directly displays the original image, and no additional processing is needed.

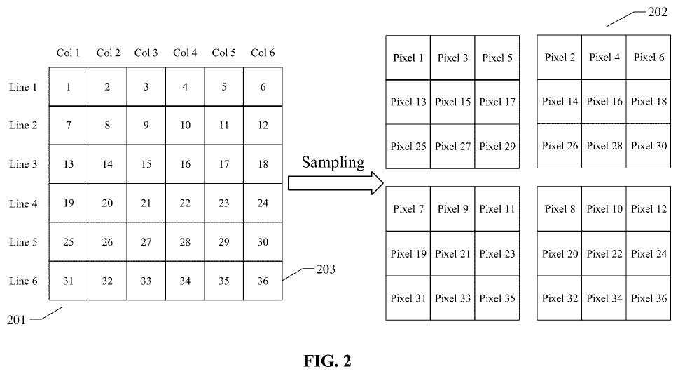

At S103, in response to the resolution of the original image being greater than the maximum display resolution, the image display device samples, in a line direction of the original image, the plurality of columns of pixels of the original image at intervals, or samples, in a column direction of the original image, the plurality of lines of pixels of the original image at intervals, or samples, in the line direction and the column direction of the original image, the plurality of lines of and the plurality of columns of pixels of the original image at intervals, to generate a×b sub-images, herein a refers to a number of sub-images generated by sampling in the line direction of the original image, b refers to a number of sub-images generated by sampling in the column direction of the original image, both a and b are positive integers, and at least one of a and b is greater than 1. Referring to FIG. 2, FIG. 2 shows an exemplary original image 201 having 36 pixels 203. The original image 201 may of course include many more pixels 203, such as 8,847,360 pixels (4K 2160P), here an original image 201 having 36 pixels 203 is taken as an example for simplifying illustration.

As shown in FIG. 2, the original image 201 has 6 lines of and 6 columns of pixels 203, in the line direction of the original image 201, sampling is performed on the 6 columns of pixels 203 at an interval of one column, and in the column direction of the original image 201, sampling is performed on the 6 lines of pixels 203 at an interval of one line. In this way, four, i.e. 2×2, sub-images 202 are generated, and each sub-image has 9 pixels coming from a part of 3 lines of pixels 203 and a part of 3 columns of pixels 203 of the original image 201. Other combinations of values of a and b are also possible, such as a=1 and b=3, a=3 and b=2, or the like. With the variation of the values of a and b, the interval in the line direction and the interval in the column direction for the sampling are accordingly adjusted. In some embodiments, the interval in the line direction for the sampling is valued as (a-1), and the interval in the column direction for the sampling is valued as (b-1). In other words, in the line direction of the original image 201, the plurality of lines of pixels 203 are sampled at an interval of (a-1) columns, and in the column direction of the original image 201, the plurality of columns of pixels 203 are sampled at an interval of (b-1) lines. Other values for the sampling intervals in the line and column directions are also possible, and the present disclosure is not limited to this.

It should be understood that the sampling may be performed only in the line direction or only in the column direction of the original image, as needed. In this case, taking the original image as shown in FIG. 2 as an example, 1×2 or 2×1 sub-images may be generated by sampling. In other words, one of a and b equals to 1.

It is noted that each of the sub-images generated by the sampling as illustrated above is not a corner of the original image. Taking an original image having many more pixels as an example, such as 4096×2160 pixels, each of the 4 generated sub-images has 2048 columns of and 1080 lines of pixels that almost go across the entire original image. Therefore, each of the generated sub-images is a unique low resolution version of the entire original image, rather than a part of the original image having the same pixel density.

In some embodiments, when resolution of the original image cannot be evenly divisible by the maximum display resolution, image interpolation algorithms, such as nearest interpolation, bilinear interpolation, or bicubic interpolation, may be used together with the sampling operation as illustrated above to generate the a×b sub-images. Other appropriate image interpolation algorithms may also be taken into account, and the present disclosure is not limited to this.

At S104, the image display device displays the a×b sub-images one by one at a display frame rate F. In some embodiments, the display frame rate F is selected, in order to provide the user with perception of viewing an image of high resolution. Referring to the example as shown in FIG. 2, 4 sub-images 202 are generated by performing sampling on the original image 201, provided that the image display device further has a preset display frame rate f, then the value of the display frame rate F may be selected to be 4 times the value of the preset display frame rate f, since a number of the sub-images 202 to be displayed (in this example, 4) is four times a number of the original image 201 (in this example, 1). In other words, the value of the display frame rate F may be selected to be a product of f and a number of generated sub-images 202, namely the display frame rate F meets F=f×a×b. In this way, the generated sub-images of low resolution are displayed at a high frame rate being several times the preset display frame rate of the image display device, and the user can perceive the original image of high resolution due to the principle of persistence of vision.

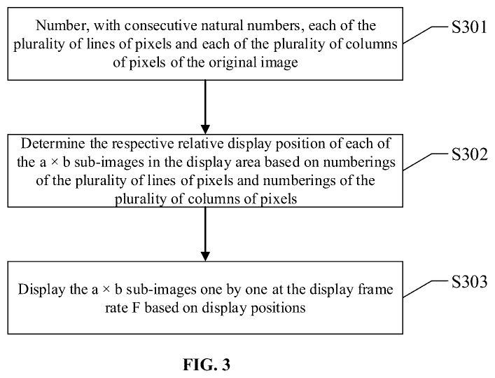

The operation of displaying the a×b sub-images further includes the determination of respective display position of each of the a×b sub-images in a display area of the image display device for displaying the original image, and the display of the a×b sub-images based on display positions. In some embodiments, referring to FIG. 3, the determination of respective display position of each of the a×b sub-images in the display area may include operations as follows.

At S301, the image display device may number, with consecutive natural numbers, each of the plurality of lines of pixels and each of the plurality of columns of pixels of the original image 201 in a way as shown in FIG. 2. In this way, each of the generated sub-images 202 corresponds to a plurality of numberings of lines of pixels and a plurality of numberings of columns of pixels.

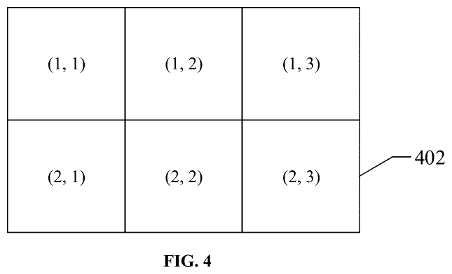

At S302, the image display device may determine the respective relative display position of each of the a×b sub-images in the display area based on numberings of the plurality of lines of pixels and numberings of the plurality of columns of pixels. The image display device may number each of the generated sub-images with a respective minimum line numbering and a respective minimum column numbering of the corresponding plurality of numberings of lines and the corresponding plurality of numberings of columns. Referring to FIG. 4, FIG. 4 shows exemplary sub-images 402 numbered with respective minimum line numberings and respective minimum column numberings, and the numbering of each numbered sub-images 402 is in a form of (x, y). The image display device may call the values of “x” in the numberings of sub-images 402, and determine that the sub-images 402 having minimum value of “x”, such as 1, are displayed as the uppermost line in the display area. With the value of “x” increases, the corresponding sub-images 402 are displayed as relatively lower lines in the display area. The image display device may further call the values of “y” in the numberings of sub-images 402, and determine that the sub-images 402 having minimum value of “y”, such as 1, are displayed as the left-most column in the display area. With the value of “y” increases, the corresponding sub-images 402 are displayed as relatively dextral columns in the display area. In this way, the relative display positions of the a×b sub-images in the display area can be determined, and the offset between adjacent sub-images in the line direction may be (a-1) columns, i.e. the sampling interval in the line direction, and the offset between adjacent sub-images in the column direction may be (b-1) lines, i.e. the sampling interval in the column direction.

At S303, with the respective relative display position of each of the a×b sub-images in the display area is determined, the image display device may display the sub-images one by one at the display frame rate F based on the determined display positions.

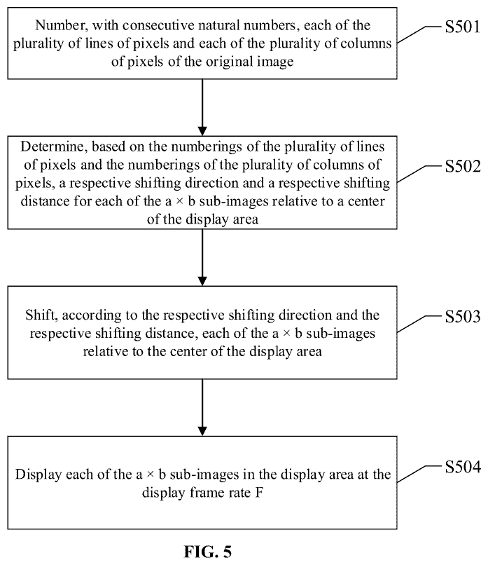

In some other embodiments, referring to FIG. 5, the determination of respective display position of each of the a×b sub-images in the display area may include operations as follows.

At S501, the image display device may number, with consecutive natural numbers, each of the plurality of lines of pixels and each of the plurality of columns of pixels of the original image. This operation may be performed in a similar way as illustrated above, and will not be repeated here.

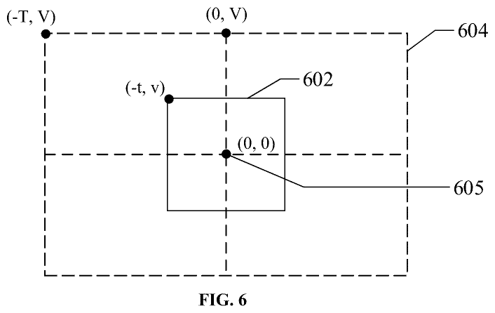

At S502, the image display device may determine, based on the numberings of the plurality of lines of pixels and the numberings of the plurality of columns of pixels, a respective shifting direction and a respective shifting distance for each of the a×b sub-images relative to a center of the display area. The image display device may number each of the generated sub-images, in the form of (x, y), with a respective minimum line numbering and a respective minimum column numbering. The numbering operation is similar to that as illustrated above, and will not be repeated here. The image display device may call the sub-image having the minimum values of x and y, i.e. the sub-image numbered (1, 1) as a first sub-image. Referring to FIG. 6, then the image display device may establish a coordinate system with the center 605 of the display area 604 as the origin, and therefore determine coordinates of boundaries of the first sub-image 602 and coordinates of boundaries of the display area 604. For example, see FIG. 6, when the first sub-image 602 is in its initial position in the display area 604, a center of the first sub-image 602 is coincident with the center 605, and it may be determined that a coordinate of the upper-left vertex of the first sub-image 602 is (−t, v), and a coordinate of the upper-left vertex of the display area 604 is (−T, V). It may be further determined, according to the numbering (1, 1) of the first sub-image 602, that a shifting direction of the first sub-image 602 relative to the center 605 of the display area 604 is from the upper-left vertex of the first sub-image 602 to the upper-left vertex of the display area 604, and a shifting distance of the first sub-image 602 relative to the center 605 is \sqrt{(T−t)²+(V−v)²}. With respect to a second sub-image with numbering (1, 2), it may be determined, according to the numbering (1, 2), that a shifting direction of the second sub-image relative to the center 605 has a rightward offset of one column relative to the first sub-image 602; and a shifting distance of the second sub-image relative to the center 605 may be determined accordingly. Shifting directions and shifting distances for other sub-images may be determined in a similar way, which will not be repeated here.

Referring to FIG. 5, the display of the a×b sub-images one by one at the display frame rate F based on the display positions may include operations as follows.

At S503, the image display device may shift, according to the respective shifting direction and the respective shifting distance, each of the a×b sub-images relative to the center of the display area. After the respective shifting directions and shifting distances are determined, during the display of the a×b sub-images, the image display device may shift each of the sub-images by a respective shifting direction and a respective shifting distance in the display area.

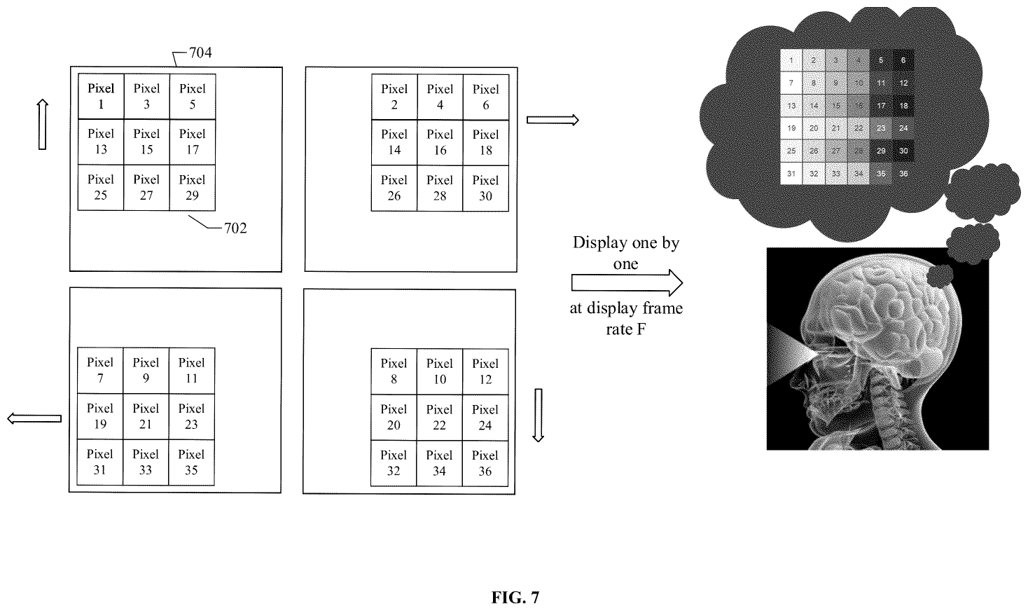

At S504, the image display device may display each of the a×b sub-images in the display area at the display frame rate F. Referring to FIG. 7, due to the different relative display positions or to the different shifting directions and shifting distances, sub-images 702 are displayed, at a high display frame rate F, in different positions in the display area 704. When the display frame rate F is high enough, such as 120 fps, 200 fps, 240 fps or the like, the continuously displayed sub-images 702 will make the user to perceive the high-resolution original image, due to persistence of vision.

In some embodiments, the image display device may communicate with the external image source via an optical waveguide, and the optical waveguide includes at least optical fibers.

In some embodiments, the image display device may include, but not limited to, a projector, in particular a digital light processing (DLP) projector, VR glasses and a liquid crystal display, such as a liquid crystal on silicon (LCoS) display, a uLED display or the like.

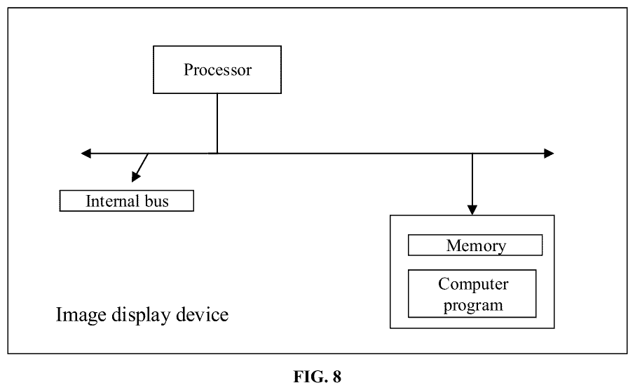

Referring to FIG. 8, embodiments of the present disclosure further provide an image display device. The image display device includes a memory and a processor, and the memory is configured to store a computer program, which, when executed by the processor, causes the processor to implement operations of the image display method as illustrated above. In terms of hardware, the image display device may include a processor, an internal bus and a memory. The memory may include an internal memory and a non-transitory memory. The processor reads a corresponding computer program from the non-transitory memory and runs the computer program in the internal memory. Those skilled in the art may understand that the structure as shown in FIG. 8 is only an example rather than a limitation to the structure of the above image display device. For example, the image display device may include more or less components than those shown in FIG. 8. For example, the image display device may further include other processing hardware, such as a graphics processing unit (GPU) or an external communication port. Apart from a hardware implementing manner, the present disclosure does not exclude other implementing manner, for example, through a logic device or a combination of software and hardware.

Moreover, the processor may include a central processing unit (CPU) or a GPU, and may include other components such as a single-chip microcomputer capable of logical processing, a logic gate circuit and an integrated circuit and the like or a combination thereof. The memory disclosed in this embodiment may be a memory device for storing information. In a digital system, a device capable of storing binary data may be a memory. In an integrated circuit, a circuit with a storing function but without a physical form may also be a memory, for example, a random access memory (RAM), a first input first output (FIFO) memory and the like. In a system, a memory device with an entity form may also be called a memory. In implementation, the memory may be implemented as a cloud memory, to which the present disclosure does not put a limitation.

Through description in the above embodiment, those skilled in the art may clearly know that the embodiments may be implemented through software and a necessary general hardware platform, or through hardware. Based on this, contents that substantively makes contribution to the existing technology may be embodied through software products. The computer software product may be stored in a storage medium such as an ROM/RAM, magnetic disc, optical disc and so on. The storage medium includes some instructions to enable a computer device (which may be a personal computer, a server or a network device and the like) to execute the methods of the embodiments or some parts of the embodiments.

The above-described are only some embodiments of the present disclosure, but are not used to impose a limitation to the present disclosure. Any amendment, equivalent substitution and improvement made within the spirit and principle of the present disclosure shall be included in the protection scope of the present disclosure.

What is claimed is:

1. An image display method, applicable to an image display device having maximum display resolution, wherein the method comprises:
receiving an original image from an external image source, wherein the original image has a plurality of lines of and a plurality of columns of pixels;
determining whether resolution of the original image is greater than the maximum display resolution;
in response to the resolution of the original image being greater than the maximum display resolution,
sampling, in a line direction of the original image, the plurality of columns of pixels of the original image at intervals, or
sampling, in a column direction of the original image, the plurality of lines of pixels of the original image at intervals, or
sampling, in the line direction and the column direction of the original image, the plurality of lines of and the plurality of columns of pixels of the original image at intervals,
to generate a×b sub-images, wherein a refers to a number of sub-images generated by sampling in the line direction of the original image, b refers to a number of sub-images generated by sampling in the column direction of the original image, both a and b are positive integers, and at least one of a and b is greater than 1; and
displaying the a×b sub-images one by one at a display frame rate F.

2. The method according to claim 1, wherein sampling, in the line direction and the column direction of the original image, the plurality of lines of and the plurality of columns of pixels of the original image at intervals includes:
sampling, in the line direction of the original image, the plurality of lines of pixels of the original image at an interval of (a-1) columns, and sampling, in the column direction of the original image, the plurality of columns of pixels of the original image at an interval of (b-1) lines.

3. The method according to claim 1, wherein the image display device further has a display area for displaying the original image, and displaying the a×b sub-images one by one at the display frame rate F includes:
determining a respective display position of each of the a×b sub-images in the display area; and
displaying the a×b sub-images one by one at the display frame rate F based on display positions.

4. The method according to claim 3, wherein determining the respective display position of each of the a×b sub-images in the display area includes:
numbering, with consecutive natural numbers, each of the plurality of lines of pixels and each of the plurality of columns of pixels of the original image; and
determining the respective relative display position of each of the a×b sub-images in the display area based on numberings of the plurality of lines of pixels and numberings of the plurality of columns of pixels.

5. The method according to claim 3, wherein determining the respective display position of each of the a×b sub-images in the display area includes:
numbering, with consecutive natural numbers, each of the plurality of lines of pixels and each of the plurality of columns of pixels of the original image; and
determining, based on the numberings of the plurality of lines of pixels and the numberings of the plurality of columns of pixels, a respective shifting direction and a respective shifting distance for each of the a×b sub-images relative to a center of the display area.

6. The method according to claim 5, wherein displaying the a×b sub-images one by one at the display frame rate F based on the display positions includes:
shifting, according to the respective shifting direction and the respective shifting distance, each of the a×b sub-images relative to the center of the display area; and
displaying each of the a×b sub-images in the display area at the display frame rate F.

7. The method according to claim 1, wherein the image display device further has a preset display frame rate f, and F=f×a×b.

8. The method according to claim 1, in response to the resolution of the original image cannot being evenly divisible by the maximum display resolution, the method includes:
sampling, in at least one of the line direction and the column direction of the original image, the plurality of lines of and the plurality of columns of pixels of the original image at intervals and using an image interpolation algorithm, to generate the a×b sub-images.

9. The method according to claim 1, wherein the image display device communicates with the external image source via an optical waveguide, and the optical waveguide includes at least optical fibers.

10. The method according to claim 1, wherein the image display device includes a projector, a liquid crystal display and VR glasses.

11. An image display device, comprising a memory and a processor, wherein the memory is configured to store a computer program, which, when executed by the processor, causes the processor to implement operations of an image display method, and wherein the image display method comprises:
receiving an original image from an external image source, wherein the original image has a plurality of lines of and a plurality of columns of pixels;
determining whether resolution of the original image is greater than the maximum display resolution;
in response to the resolution of the original image being greater than the maximum display resolution,
sampling, in a line direction of the original image, the plurality of columns of pixels of the original image at intervals, or
sampling, in a column direction of the original image, the plurality of lines of pixels of the original image at intervals, or
sampling, in the line direction and the column direction of the original image, the plurality of lines of and the plurality of columns of pixels of the original image at intervals,
to generate a×b sub-images, wherein a refers to a number of sub-images generated by sampling in the line direction of the original image, b refers to a number of sub-images generated by sampling in the column direction of the original image, both a and b are positive integers, and at least one of a and b is greater than 1; and
displaying the a×b sub-images one by one at a display frame rate F.

12. The device according to claim 11, wherein the operation of sampling, in at least one of the line direction and the column direction of the original image, the plurality of lines of and the plurality of columns of pixels of the original image at intervals includes:
sampling, in the line direction of the original image, the plurality of lines of pixels of the original image at an interval of (a-1) columns, and sampling, in the column direction of the original image, the plurality of columns of pixels of the original image at an interval of (b-1) lines.

13. The device according to claim 11, further having a display area for displaying the original image, wherein the operation of displaying the a×b sub-images one by one at the display frame rate F includes:
determining a respective display position of each of the a×b sub-images in the display area; and
displaying the a×b sub-images one by one at the display frame rate F based on display positions.

14. The device according to claim 13, wherein the operation of determining the respective display position of each of the a×b sub-images in the display area includes:
numbering, with consecutive natural numbers, each of the plurality of lines of pixels and each of the plurality of columns of pixels of the original image; and
determining the respective relative display position of each of the a×b sub-images in the display area based on numberings of the plurality of lines of pixels and numberings of the plurality of columns of pixels.

15. The device according to claim 14, wherein the operation of determining the respective display position of each of the a×b sub-images in the display area includes:
numbering, with consecutive natural numbers, each of the plurality of lines of pixels and each of the plurality of columns of pixels of the original image; and
determining, based on the numberings of the plurality of lines of pixels and the numberings of the plurality of columns of pixels, a respective shifting direction and a respective shifting distance for each of the a×b sub-images relative to a center of the display area.

16. The device according to claim 15, wherein the operation of displaying the a×b sub-images one by one at the display frame rate F based on the display positions includes:
shifting, according to the respective shifting direction and the respective shifting distance, each of the a×b sub-images relative to the center of the display area; and
displaying each of the a×b sub-images in the display area at the display frame rate F.

17. The device according to claim 11, further having a preset display frame rate f, wherein F=f×a×b.

18. The device according to claim 11, wherein in response to the resolution of the original image cannot being evenly divisible by the maximum display resolution, the method includes:
sampling, in at least one of the line direction and the column direction of the original image, the plurality of lines of and the plurality of columns of pixels of the original image at intervals and using an image interpolation algorithm, to generate the a×b sub-images.

19. The device according to claim 11, communicating with the external image source via an optical waveguide, wherein the optical waveguide includes at least optical fibers.

20. The device according to claim 11, wherein the device includes a projector, a liquid crystal display and VR glasses.
